(19) United States
(12) Patent Application Publication
(10) Pub. No.: US 2008/0242293 A1
(43) Pub. Date: Oct. 2, 2008

(54) System and method for providing caller id name display in wireless communications system

(75) Inventor: Mark H. Gosselin, Seattle, WA (US)

Correspondence Address: Frank Frisenda, Jr.;Frisenda, Quinton & Nicholson, Suite 200, 8275 So. Eastern Avenue, Las Vegas, NV, 89123, US

(73) Assignee: Cequint, Inc.

(21) Appl. No.: 11/732,445

(22) Filed: Apr. 2, 2007

(51) Int. Cl. H04Q 7/20

(52) U.S. Cl. 455/425

(57) ABSTRACT

System and method for providing caller name display in a wireless communications system. The method includes receiving an originating telephone number at a mobile device, storing the originating number in the mobile device, transmitting a name lookup request for the originating number from the mobile device to a server, receiving a response including a name corresponding to the originating number from the server, storing the name and displaying the name when a call having the same originating number is received. The system includes a mobile device having a display, a memory and a processor. The system also includes a software module configured to store an originating telephone number in the memory, send a name lookup request to a server, receive and store a response including a name corresponding to the originating number and display the name when a call having the same originating number is received.

### FIELD OF THE INVENTION

This invention relates generally to systems and methods for caller identification and, more specifically, to caller name display in a wireless communications system.

### BACKGROUND OF THE INVENTION

In current wireless mobile communications systems, caller name (CNAM) data is typically delivered with a network page request that alerts a mobile handset or terminal (MT) of an incoming call. The CNAM information is queried from a network database when a call is initiated and is then sent from a mobile switching center (MSC) to the MT. An operating system (OS) layer on the MT responsible for call processing decodes caller number identification (CNID) and CNAM information for display to a user of the MT. The user may then view the CNAM and CNID information of a person trying to call them and make a decision as to whether they will answer or ignore the call.

There are a number of disadvantages to this approach to caller identification information display in a wireless environment. Current communications systems typically require significant infrastructure investment for carriers to deploy the technology. Additionally, many mobile terminals are not able to receive and display caller name information from a wireless network without modification. Also, this method can require a CNAM database query for every incoming call, even for multiple calls received from the same originating number. This is disadvantageous because CNAM databases are typically fee based, meaning that a fee is charged every time the database is queried or every time the database provides a result, or both.

Although technology has been developed for querying databases from a mobile handset to obtain name information associated with a telephone number, this technology suffers from a number of limitations. For example, U.S. Pat. No. 7,088,994 to Uhlmann requires input from a user to initiate a name lookup process and is limited to the presentation of calling name information before placing a call rather than as the call is received.

Accordingly, there is a need for a system and method for caller name display in a wireless communications system that is compatible with most wireless handsets without modification, which does not require a database query every time a call is received from the same number, and which does not require user input to function.

### SUMMARY OF THE INVENTION

The present invention includes a system and method for providing caller name display in a wireless communications system. The preferred system includes a mobile device having a display, a memory, and a processor. The system also includes a software module configured to store an originating telephone number in the memory, send a name lookup request to a server, receive and store a response including a name corresponding to the originating number, and display the name when a call having the same originating number is received.

The preferred method includes receiving an originating telephone number at a mobile device, storing the originating number in the mobile device, transmitting a name lookup request for the originating number from the mobile device to a server, receiving a response including a name corresponding to the originating number from the server, storing the name in association with the originating number, and displaying the name when a call having the same originating number is received.

In accordance with further aspects of the invention, the method includes determining whether the received originating number is already associated with a name in the mobile device before transmitting a name lookup request, wherein a name lookup request is not transmitted if the originating telephone number is already associated with a name in the mobile device.

In accordance with additional aspects of the invention, the method includes receiving a calling name update from the server and storing the calling name update in the mobile device.

As will be readily appreciated from the foregoing summary, the invention provides a system and method for providing caller name display in a wireless communications system.

### BRIEF DESCRIPTION OF THE DRAWINGS

Preferred and alternative embodiments of the present invention are described in detail below with reference to the following drawings.

FIG. 1 is a block diagram showing a network environment of a system for providing caller name display in accordance with an embodiment of the invention;

FIG. 2 is a block diagram showing additional detail for the system of FIG. 1, in accordance with an embodiment of the invention; and

FIG. 3 is a flowchart of a method of providing caller name display information in accordance with an embodiment of the invention.

### DETAILED DESCRIPTION OF THE PREFERRED EMBODIMENT

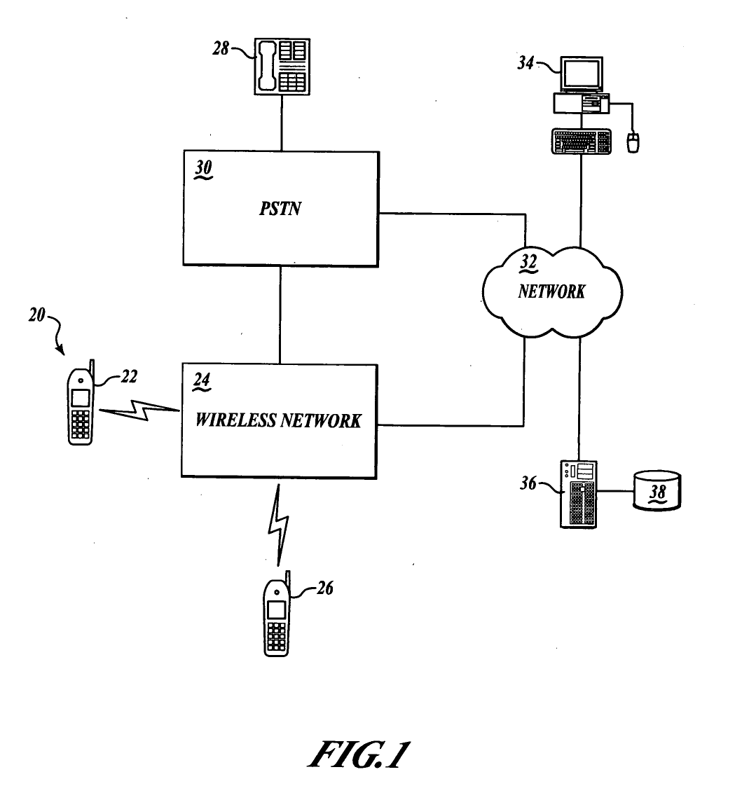

FIG. 1 is a block diagram showing a system 20 for providing caller name display in a network environment in accordance with an embodiment of the invention. The system 20 includes a mobile terminal (MT) 22, also referred to as a mobile device 22, such as a cellular wireless telephone handset in an exemplary embodiment. The MT 22 is in signal communication with a wireless network 24 that enables the MT 22 to communicate with a variety of other devices. For example, a user of the MT 22 is able to communicate with a user of a second MT 26, also in wireless signal communication with the wireless network 24. In other embodiments, the second MT 26 is in wireless communication with a second wireless network (not shown) that allows it to communicate with the first MT 22. In one embodiment, the wireless network 24 is a code division multiple access (CDMA) network. In alternative embodiments other wireless technologies such as a Global System for Mobile Communications (GSM) network may be used.

The MT 22 is also able to communicate with landline telephones or other devices such as a telephone 28 connected to a public switched telephone network (PSTN) 30, which is linked to the wireless network 24. In this example, both the wireless network 24 and the PSTN 30 are also linked to a network 32 that is the Internet in an exemplary embodiment, but may be other public or private networks in other embodiments. This allows the MT 22 to communicate with other devices connected to the network 32 using a packet data protocol. For example, a user of the MT 22 is able to communicate with a computer 34 that is connected to the network 32. Additionally, the MT 22 is able to communicate with a server 36 connected to the network 32 through one or more communication mediums in a way that allows the server 36 to provide information to the MT 22.

The server 36 is in data communication with a database 38 in a way that allows the server 36 to query the database 38 and provide information to the MT 22. In this example, the MT 22 receives a network page containing an originating (calling) telephone number from the wireless network 24 indicating a call is being placed to the MT 22. The originating telephone number contained in the network page is stored on the MT 22. Then, a request is sent from the MT 22 to the server 36 via the wireless network 24 and the network 32 using the originating number as a parameter so that the server 36 is able to query the database 38 using the originating number to obtain a calling name associated with the originating number that is then passed back to the MT 22 in a response. The MT 22 then stores the calling name so that when the same calling number is received at the MT 22 in a future network page, the calling name associated with that calling number is presented to a user of the MT 22. In an exemplary embodiment, the calling name is stored in association with the calling number in a contacts list contained at the MT 22. It is advantageous to have the calling name locally associated with the calling number, thus allowing the calling name contained in the contacts list to be automatically presented upon receipt of a call containing a number associated with the calling name utilizing native software included in many operating systems of current mobile devices.

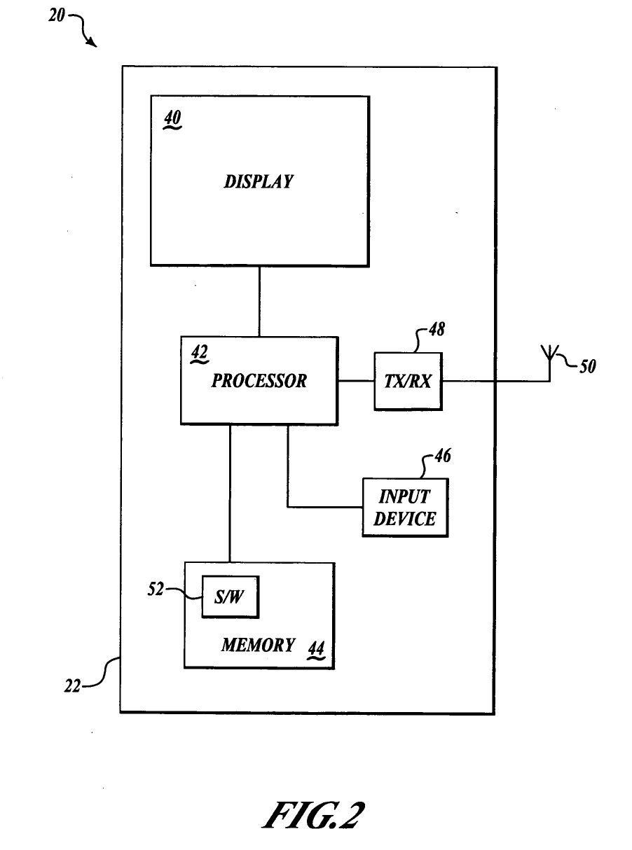

FIG. 2 is a block diagram showing additional detail for the system 20 of FIG. 1 in accordance with an exemplary embodiment of the invention. The MT 22 includes a display 40, a processor 42 in signal communication with the display 40, a memory 44 in data communication with the processor 42, an input device 46 in signal communication with processor 42, and a transceiver 48 in signal communication with both the processor 48 and an antenna 50. The input device 46 is a numeric keypad in some embodiments of the invention. However, in other embodiments, the input device 46 also includes a keyboard, a scroll wheel, a pointing device, or may be integrated with a touch screen display that is used for both input and display functions. In the embodiment shown, the transceiver 40 is a single unit. However, in other embodiments, the transceiver includes a separate transmitter and a separate receiver. The memory 44 may include nonvolatile memory. However, in other embodiments, the memory 44 may include both nonvolatile memory as well as other types of data storage, such as a removable memory card. A software module 52 is stored in the memory 44 for operation of the processor 42. In an exemplary embodiment, the software module 52 includes components coded using Qualcomm, Inc.'s Binary Runtime Environment for Wireless (BREW®). However, in other embodiments, the software module 52 includes components coded in a different manner, such as with Sun Microsystems, Inc.'s Java 2 Micro Edition (J2ME), for example. A power supply (not shown) is used to power the MT 22.

While not show for clarity, the software module 52 preferably includes a number of components. In an example embodiment, the software module 52 includes a first component configured to store a previously received originating telephone number included as a part of a network page in the memory 44 and a second component configured to send a name lookup request for the originating phone number to the server 36 shown in FIG. 1 using a packet data protocol. In one embodiment, the network page is received over a CDMA network. However, in other embodiments, the network page is received over other types of wireless networks, such as a GSM network.

The software module 52 preferably includes a third component configured to receive a response to the lookup request from the server 36, the response including a name corresponding to the originating telephone number. The software module 52 preferably includes a fourth component configured to store the received name in the memory 44 in association with the originating telephone number and a fifth component configured to display the name using the display 40 when a network page is received that contains the originating telephone number stored in association with the name. In one embodiment, the fourth component is configured to store the received name in a contacts list on the MT 22. However, in other embodiments, the received name is stored in a call log and/or in a separate database residing on the MT 22.

In an alternative embodiment, the software module 52 includes a sixth component configured to perform a lookup process within the MT 22 using the originating telephone number to obtain the stored name corresponding to the originating telephone number before the fifth component displays the name. Additionally, the software module 52 may include a seventh component configured to determine whether the received originating telephone number is already associated with a name within the MT 22 before the second component executes. In this embodiment, the second component is configured not to send the name lookup request if the seventh component determines that the received originating telephone number is already associated with a name. In this embodimentthe third and fourth components, in turn, are configured not to run if the second component does not send the lookup request.

In an alternative embodiment, the software module 52 includes an eighth component configured to receive a calling name update from the server 36 and a ninth component configured to store the calling name update in the memory 44. The software module 53 also includes a tenth component configured to send a calling name request to the server before the eight component executes in certain embodiments.

Although the system 20 includes the software module 52 in this embodiment, in other embodiments the processor 44 may include one or more independent or collaborative modules configured to perform the functions carried out by any or all of the software module 52 components.

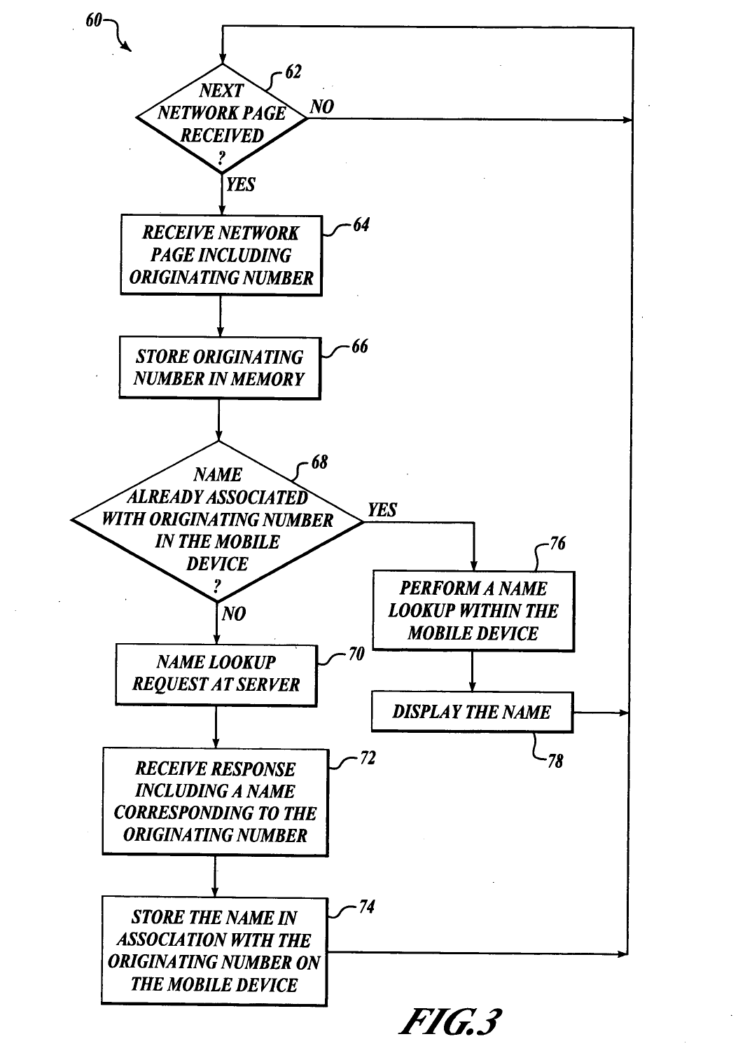

FIG. 3 is a flowchart of a method 60 of providing caller name display information in accordance with an embodiment of the invention. The method 60 begins at a decision block 62, where a determination is made whether a next network page has been received at the mobile device (MT 22). If the next network page has not been received, the method remains at the decision block 60. If the next network page is received, the method proceeds to a block 64 where a network page including an originating telephone number is received at a mobile device such as the MT 22 shown in FIGS. 1 and 2. The network page may be received, for example, over a CDMA network. In alternative embodiments the network page is received over a different type of network such as a GSM network. Next, at a block 66, the originating number is stored in the memory 44. In a preferred embodiment, the originating number is taken directly from the network page data before storage. In alternative embodiments, the originating number is obtained from another source, such as after the MT 22 has stored the originating number contained in the network page in a call log.

Next, at a decision block 68, it is determined whether a name is already associated with the originating number in the MT 22. If a name is not already associated with the originating number in the MT 22, the method proceeds to a block 70 where a name lookup request is transmitted to a server, such as the server 36. By way of example, the lookup request may be transmitted using a packet data protocol. At block 70 the name lookup is accomplished and the information transmitted to the MT 22. At a block 72 a response, including a name corresponding to the originating number, is received from the server 36 at the MT 22. Next, at a block 74, the name is stored in association with the originating number at the MT 22. The logic then returns to the decision block 62.

If, at the decision block 68, it is determined that a name was already associated with the originating number in the mobile device, the logic proceeds to a block 76, where a name lookup is performed at the mobile device. Next, at a block 78, the name is displayed on the MT 22 so that a user of the MT 22 may decide whether to answer the call based upon a displayed name. A call log maintained in memory 44 and associated with processor 42 and display 40, which preferably records all incoming calls to and outgoing calls from the mobile device, may be used to source the information displayed at block 78. The logic of the method 60 then returns to the decision block 62.

In the above described embodiment the decision block 68 and the block 76 are shown as separate steps. However, in other embodiments, the decision block 68 and the block 76 may be combined into a single step in such a way that a name lookup is always performed. In this embodiment, if no associated name is found, the method 60 proceeds to the block 70. If an associated name is found, the method proceeds to the block 78. Although the name is visually displayed in the described embodiment, alternative embodiments may use other forms of notifying the user, such as by audibly alerting the user, for example, by speaking the name in a synthesized voice.

In an alternative embodiment, the method 60 further includes an update process. The update process begins with an update request being sent from the MT 22 to the server 36. In this embodiment, the server 36 is configured to maintain a database containing the originating telephone numbers and associated names for the MT 22 and other mobile devices. The database 38 is a CNAM database that is periodically updated as new information is gathered by the database 38 provider. Periodically, the server 36 updates its list of stored originating number and corresponding caller names by checking its list against the list in the database 38. In one embodiment, the server 36 updates its list after an update request is received. In alternative embodiments, the server updates its list at predetermined time intervals. After the server 36 receives the update request from the MT 22, it sends a response to the MT 22 that contains updated originating number and caller name pairs for any pairs that have changed since they were last sent from the server to the MT 22. Although the update process is initiated by an update request from the MT 22 in this embodiment, in other embodiments the server 36 may automatically send updates to the MT 22 at predetermined time intervals or as any changes are made to the server 36 list after the server 36 compares its list to that maintained in the database 38.

While the preferred embodiment of the invention has been illustrated and described, as noted above, many changes can be made without departing from the spirit and scope of the invention. For example, in an alternative embodiment the system and method may be modified to determine at decision block 62 a name associated with an outgoing number for a call placed from the mobile device, or augmented to allow for determining a name associated with either an incoming network page or an outgoing call. In these embodiments, at block 64 a number is captured, either from an incoming network page or an outgoing call. The steps of block 66 through block 78 occur as described above, ultimately determining and displaying the name associated with either the incoming network page or outgoing call number. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for caller name display in a mobile wireless communication system, comprising:
a mobile wireless device having a memory, a processor in data communication with the memory, a display in signal communication with the processor and a network interface in signal communication with the processor; and
a software module for storage in the memory and operable by the processor, the software module comprising:
a first component configured to store a previously received originating telephone number included as part of a network page in the memory;
a second component configured to send a name lookup request for the originating phone number to a server;
a third component configured to receive a response to the lookup request from the server, the response including a name corresponding to the originating phone number;
a fourth component configured to store the received name corresponding to the originating telephone number in association with the originating telephone number in the memory; and
a fifth component configured to display the name using the display.

2. The system of claim 1, wherein the first component is configured to store a previously received originating telephone number included as part of a network page over a code division multiple access (CDMA) network in the memory.

3. The system of claim 1, wherein the first component is configured to store a previously received originating telephone number included as part of a network page over a Global System for Mobile Communications (GSM) network in the memory.

4. The system of claim 1, wherein the fourth component is further configured to store the received name in a contacts list.

5. The system of claim 1, wherein the software module further comprises a sixth component configured to perform a lookup process within the mobile device using the originating telephone number to obtain the stored name corresponding to the originating telephone number.

6. The system of claim 5, wherein the software module further comprises a seventh component configured to determine whether the received originating telephone number is associated with a name in the mobile device, wherein the second component is configured to not send the name lookup request if the seventh component determines the received originating telephone number is already associated with a name in the mobile device and wherein the third and fourth components are configured not to run if the second component does not send the lookup request.

7. The system of claim 1, wherein the software module further comprises:
an eighth component configured to receive a calling name update from the server; and
a ninth component configured to store the calling name update in memory.

8. The system of claim 7, wherein the software module further comprises a tenth component configured to send a calling name update request to the server before the eighth and ninth components are run.

9. A method for caller name display in a mobile wireless communication system, comprising:
obtaining a telephone number at a wireless mobile device having a memory, a display and a processor in signal communication with the memory and the display;
storing the telephone number in the memory;
transmitting a name lookup request for the telephone phone number from the mobile device to a server;
receiving a response to the transmitted name lookup request from the server, the response including a name corresponding to the telephone number;
storing the received name corresponding to the telephone number in association with the telephone number in the memory; and
displaying the name using the display.

10. The method of claim 9, wherein the telephone number obtained at the wireless mobile device is an outgoing telephone number.

11. The method of claim 9, wherein obtaining a telephone number at a wireless mobile device comprises receiving a first network page including an originating telephone number.

12. The method of claim 11, further comprising the following steps before displaying the name:
receiving a second network page including the originating telephone number received in the first network page; and
performing a look-up process within the mobile device using the originating telephone number to obtain the stored name corresponding to the originating telephone number.

13. The method of claim 9, wherein the received name is stored in a contacts list.

14. The method of claim 11, further comprising:
after receiving the first page, determining whether the received originating telephone number is associated with a name in the mobile device before transmitting a name lookup request; and
if the originating telephone number is associated with a name,
avoiding transmitting a name lookup request, receiving a response to the transmitted name lookup request and storing the received name corresponding to the originating telephone number in association with the originating telephone number in the memory; and
displaying the name in the mobile device associated with the originating telephone number using the display.

15. The method of claim 9, further comprising:
receiving a name update from the server; and
storing the name update in the memory.

16. The method of claim 15, further comprising sending a name update request to the server before receiving a name update.

17. The method of claim 15, wherein the name update includes at least one of a new name for a stored telephone number and a new telephone number for a stored name.

18. The method of claim 9, wherein the network page is received over a code division multiple access (CDMA) network.

19. The method of claim 9, wherein the network page is received over a Global System for Mobile Communications (GSM) network.
